(19) United States
(12) Patent Application Publication
(10) Pub. No.: US 2021/0035249 A1
(43) Pub. Date: Feb. 4, 2021

(54) Systems/protocol for creating an interconnected web of strong identities

(71) Applicant: Moiz Kohari, Telluride, CO (US)

(72) Inventor: Moiz Kohari, Telluride, CO (US)

(21) Appl. No.: 16/917,122

(22) Filed: Jun. 30, 2020

Related U.S. Application Data
(60) Provisional application No. 62/869,520, filed on Jul. 1, 2019.

(51) Int. Cl. G06Q 50/26; G06Q 30/00; G06Q 40/02; G06Q 10/10; H04L 29/06; G06F 21/60; G06F 16/22; G06N 20/00

(52) U.S. Cl. CPC G06Q 50/265; G06Q 30/0185; G06Q 30/016; G06Q 40/02; G06Q 2220/10; H04L 63/0853; G06F 21/602; G06F 16/2255; G06N 20/00; G06Q 10/10

(57) ABSTRACT

A protocol for creating, assigning, verifying and using strong end-point identities for establishing an authenticated relationship between Consumers/Users with Service Providers. The protocol allowing the Consumer accounts to directly control data attributes within the Service Provider environment using encrypted hashing techniques. The protocol defining communications between Consumers/Users, Service Providers and the Control System creating an authenticated relationship among the parties. The protocol defines a method and system for the Consumer/User to interface with one or more Service Providers, pre-authenticated directly by the Service Provider to allow the Consumer/User an authentication/verification system with pre-assigned Consumer/User data attributes that are agreed upon between the Service Provider and the Consumer. The Control System does not hold the consumer identity or any consumer attributes and operates via encrypted hashes that can only be decrypted by the Consumer/user and/or the Service Provider, making the Consumer completely anonymous to the Control System.

This application is related to, and claims priority from, U.S. Provisional Patent Application No. 62/869,520 filed Jul. 1,2019. Application 62/869,520 is hereby incorporated by reference in its entirety.

### BACKGROUND

### Field of the Invention

The present invention relates generally the exchange of electronic data in the marketplace, and in particular to a system and method that creates a strong identity for Consumers/Users that is pre-authenticated at creation and is allowed to interface with Service Providers in a trusted relationship. This allows creation of an identity marketplace and direct Consumer controlled data within a Service Provider environment. At no point does the Control System have the ability to identify the Consumer/Users, and the Control System holds no Consumer identifiable data.

### Description of the Problem Solved

Service Providers, individual consumers and government agencies may be thought of as physical end-points to any interaction that occurs among them. For example, a consumer may need to physically interface with the department of motor vehicles DMV (a government agency) to acquire a driver's license, and then the consumer may take this driver's license to a bank (a Service Provider) to open a bank account. These physical activities are usually necessary to establish a consumer's identity pursuant to certain legal and regulatory obligations, such as Anti-Money Laundering (AML) or Know Your Customer (KYC). In some cases, physical interaction may not be necessary for a Consumer/User to establish an account with a Service Provider such as opening an Internet account. However, Service Providers will usually require some authentication to prove that a Consumer/User is who they claim they are and capture other information that helps the Service Provider authenticate a Consumer/User. Electronic and digital interactions between participants usually require authentication through an identity provider (IDP) based on username/password combinations or multi-factor authentication. These systems usually require an IDP to have direct knowledge of an end-point identity. Direct knowledge is gained by capturing, storing and using Personally Identifiable Information (PII) regarding a Consumer/User, which is information that identifies, relates to, describes, is capable of being associated with, or could reasonably be linked, directly or indirectly, with a particular Consumer/User or device. Examples of PII data may include name, signature, social security number, gender, physical and genetic characteristics, address, telephone number, passport number, employment history, bank account number, credit card number, driver's license number, or any other financial information, medical information, or health insurance information. Most electronic systems require that consumers directly provide their PII information either to a Service Provider, the IDP directly or to another party, consequently resulting in the consumer losing control over this sensitive data. These systems are inherently susceptible to data breaches and information leakage.

It would be highly desirable to create systems and protocols that limit the sharing of PII with Control Systems (such as an IDP) and Service Providers (such as phone companies, banks, and the like). It would also be highly desirable to create a system, or a web of trust, where Service Providers and others can be assured that a Consumer/User is who they claim to be and that no one else can imitate the Consumer/User identity. If a trusted web of identity could be created in a system where there exist pre-validated Consumer/User data attributes, a system could be created for direct control of these data attributes by the Consumer

### SUMMARY OF THE INVENTION

The present invention relates to a system and method for direct Consumer-controlled data that stores encrypted hashes representing the data within the Control System, and only the Consumer has control of when a Service Provider can actually see the unencrypted data. In the system of the present invention, the Control System acts as the custodian of these encrypted data hashes, and helps establish a trusted relationship between the Service Provider and the Consumer/User. The trust relationship (or the web of trust) is created in a way whereby the Control System does not store consumer PII—just the encrypted hashes that are used to establish relationships between the Service Providers and the Consumers/Users. Further, this web of trust allows for the creation of a verified marketplace where Consumers/Users have control over what attributes are visible to which Service Providers, and at what time (for example, online advertisers being able to see certain data attributes such as a Consumer's FICO score, and for how long).

Accordingly, a system that generates the above defined web of trust can be leveraged to allow for direct controls by Consumers/Users over sensitive data and relationships. Emerging regulations such as General Data Privacy Regulation (GDPR) and California Consumer Protection Act (CCPA) demand that consumers have the right to their data and enterprises must prove compliance, however the mechanisms currently adopted to comply with these emerging regulations often leverage archaic mechanisms of data controls, such as SQL programming, to purge data bases of sensitive information. This is both time consuming and manual, resulting in expensive implementations that often cannot prove compliance. An object of the present invention is to create a web of trusted end-points where control can be given directly to the Consumer/User, and Service Providers do not need to burden themselves with maintaining the Consumer's/User's sensitive information; instead the Consumer/User is given direct control over their sensitive information.

### BRIEF DESCRIPTION OF THE DRAWINGS

Attention is now directed to several Figures. The implementations described within these illustrations are examples of the systems, and the scope of the present invention is not limited to only such interactions. The numerals and alphabetics correspond to the parts of the drawings in each illustration.

FIG. 1 is a block diagram illustrating the three main types of participants in the present invention; whereby a Consumer/User, a Service Provider and the Control System interact with each other over a computer network.

FIG. 2 is an illustration of a Consumer/User device (such as a mobile device, a laptop or a server), in accordance with particular embodiments of the present invention.

FIG. 3 is an illustration of a Service Provider device, whereby the device is usually represented as a server computer.

FIG. 4 is an illustration of the Control System server device; this type of a device in particular embodiments may also be referred to as the Identity Service Provider (IDP) server environment.

FIG. 5 is an illustration describing the onboarding process for a Service Provider onto the Control System, such that the Service Provider's identity can be established.

FIG. 6 is an illustration describing the onboarding process for a Consumer/User identity onto the Control System in relation to a Service Provider. Note a Consumer/User may have relationships with multiple Service Providers.

FIG. 7 is an illustration that describes the protocol for the establishment of a verified and trusted relationship between a Consumer/User and a Service Provider. During the establishment of this trusted relationship, the Service Provider agrees to giving the Consumer direct control over certain data attributes within the Service Provider's environment.

FIG. 8 depicts a real-world web of trusted identities whereby multiple Consumers/Users have relationships with multiple Service Providers via the Control System.

FIG. 9. Depicts the Attributes associated with a consumer ID (MID) and a bridge ID (BID).

FIG. 10. Is an illustration that shows Control Flow of how a Consumer/User can control data attributes, such as revoking access to an attribute for a certain Service Provider.

Several figures have been presented to illustrate features of the present invention. The scope of the present invention is not limited to what is shown in the figures.

### DESCRIPTION OF THE PREFERRED EMBODIMENTS

The present invention relates to a system for direct Consumer controlled data that stores encrypted hashes representing the data in the Control System, where only the Consumer has control of when a particular Service Provider can actually see the unencrypted data, and for how long.

The system/protocol of the present invention requires that a Service Provider must first establish a relationship with the Control System (this process is called on-boarding of a Service Provider). The Service Provider communicates with the Control System via a “Secure Enclave (SM)”, this is a piece of software sometimes known as a “driver” that establishes the unique identity for the Service Provider (including a hardware tie-in to the service provider's computer systems via hardware security modules—one example of this hardware security module is Intel's SGX platform). The Control System requires that the Service Provider have a highly verified identity through trusted third parties (such as SSL Extended Validation). Once the Control System receives the unique Service Provider attributes, the Control System creates an encrypted cryptographic hash for the Service Provider which is unique to this Service Provider; this is called a Service Provider Identifier or SID. As part of establishing the SID, the Control System also requires that the Service Provider inform the Control System which Consumer data attributes (i.e. names of fields) the Service Provider requires for establishment of a trusted connection with the Consumer/User account (such as Consumer's name, address, gender, social security number, and the like).

Next the System or Protocol requires that all Consumers/Users doing business with the particular Service Provider (that has already been on-boarded onto the Control System as described above) also be on-boarded to the Control System. The Consumer/User device must have an application that establishes secure connections between the Consumer device, the Control System and Service Providers—this application is known as the Client Secure Enclave Application. The Client Secure Enclave Application runs on the Consumer's system (such as a mobile device, laptop, server or other consumer interface device). The Client Secure Enclave Application establishes a unique identity for the Consumer/User. The unique identity associated with the Consumer may be thought of as a Digital Wallet that is created using one or a combination of biometric inputs, post quantum key distribution and other unique cryptographic key generation techniques. The Consumer's/User's unique identity along with required encrypted hash fields are passed from the Client Secure Enclave Application to the Control System. The Control System passes the above Consumer's identity and required encrypted hash fields to the Service Provider. The Secure Enclave Driver in the Service Provider environment matches the received Consumer identity attributes to verify the Consumer exists inside the Service Provider's environment. Once the Service Provider confirms the identity of the Consumer with the Control System, the Control System establishes a unique Identifier for the Consumer (this unique Consumer/User identity is called a MID). The Control System saves the Consumer's/User's required encrypted hashes (for all agreed upon data attributes between the Service Provider and Consumer/User) on the Control System in a table associated with this Consumer's/User's MID called a MID Attribute Table. Note that the Control System never stores the actual Consumer data attributes; only an encrypted hash of these data attributes is stored in the Control System, making the Consumer/User anonymous to the Control System. The Control System also creates a MID to SID hash relationship identifier, known as a Bridge identifier (BID) that can only be generated given the particular MID and SID combination.

The above described on-boarding protocol for the Service Provider and Consumer/User on the Control System establishes a highly correlated and encrypted relationship between the Service Provider and the Consumer/User. The protocol flow in this invention allows the Service Provider to access Consumer/User's sensitive information through the Control System's Secure Enclave (SM) driver that is installed on the Service Provider's system, and the Service Provider can purge the Consumer sensitive information from other areas, also called Target Systems, (such as databases and persistent stores within the Service Provider's infrastructure). A Target System is the original source of data within an enterprise. For example, an enterprise may store Consumer/User information within a SalesForce data base (or other Customer Relationship Management systems or data bases). The Service Provider may choose to retain original Consumer/User data within the existing Target Systems and simply use the Control System as an aggregation point. Meaning the Control System can act as a Master Data Repository (where data attributes are aggregated) or an Identity Master (where identity characteristics are aggregated). The Service Provider may also choose to not retain original information within existing Target Systems and only use the Control System for storage of this information.

If the Service Provider only accesses the Consumer/User sensitive information (such as PI I data) through the Secure Enclave (SM) Driver, the Service Provider unburdens itself from regulatory compliance obligations and allows the Control System to take over these regulatory obligations. The Consumer/User can interface with the Control System to instruct it to update BID Attribute Table on the Service Provider's Secure Enclave in ways such that the associated data attribute in the Service Provider's environment can be controlled per the Consumer/User's desire.

The Control System has built in Connector that allows the Control System to connect and access data from a given Target System. A Connector is a piece of software that uses different APIs to connect to different Target Systems and access data from these Target Systems. The Connectors are responsible for discovering certain types of sensitive data within a given Target System (such as PII data). The Connector may use manual processes to identify the sensitive data within a Target System, such as a User Interface to allow the Service Provider to choose what data should be identified as sensitive information (such as PII data). The Connector may also use Machine Learning and Artificial Intelligence functionality to automatically identify sensitive data within a Target System. Each different type of Target System (such as Oracle, SalesForce, MySQL, etc.) may have a different Connector that has the ability to gather data from that particular Target System.

The Connectors have the ability to recognize changes made to data attributes within the Target System or the Control System and map those changes back to the original source. The process is known as a Change Data Capture (CDC) event. For example, if a data attribute such as a phone number is updated with a certain Target System, like SalesForce, the Connector has the ability to recognize this update and it can automatically update that phone number within the Control System. Similarly, if a Consumer were to update his or her personal information within the Control System (such as a phone number or address) the Connector remembers which Target System that particular attribute came from and it can automatically update the original source of that attribute (that is, the Target System). By keeping track of the original source of data for every data attribute and identity, the Control System (via the Connector mechanism) acts as a Master Data repository (or a single source of truth). Similarly, because the Control System can keep track of identities across multiple Target Systems for a Service Provider, the Control System can also act as an Identity Master. For example, a Service Provider may have a particular Consumer identity in one Target System (SalesForce) as Mike M. Jones and the same Consumer identity in a different Target System (Oracle) as Mike Moses Jones—the Control System acting as a Identity Master can reconcile the two slightly different names to be the same identity and help the Service Provider manage the data in one place.

The Control System only identifies Consumers/Users as encrypted identities and does not have knowledge of any specific Consumer/User identity. The Consumer, at this point, has total control of their sensitive data and can enable Service Providers to view any sensitive data by unlocking the data in the Service Provider's systems through the Consumer encryption keys. The Consumer can revoke access to all or certain attributes of the Consumer's sensitive data directly by manipulating the encrypted hash keys within the Control System that in-turn prohibit the Service Provider's ability to see this data.

The Control System also has a Policy Engine component as part of the described system. The Policy Engine is responsible for controlling what data attributes are treated in what manner. For example, a Service Provider may want to allow Consumers to update their phone numbers at any time; however, if the Consumers wants to update their addresses, then they must submit utility bills with the new addresses. The Policy Engine can help the Service Provider define a policy that allows for the phone number to get updated directly. The Policy Engine will also automatically challenge the Consumer to upload a utility bill as evidence of an address change and alert the administrator at the Service Provider that they must manually accept the address change after a review of the utility bill. The Policy Engine is a programmatic interface that allows for highly sophisticated interactions to take place between the Consumer and the Service Provider, and control how data attributes are allowed to be updated or accessed.

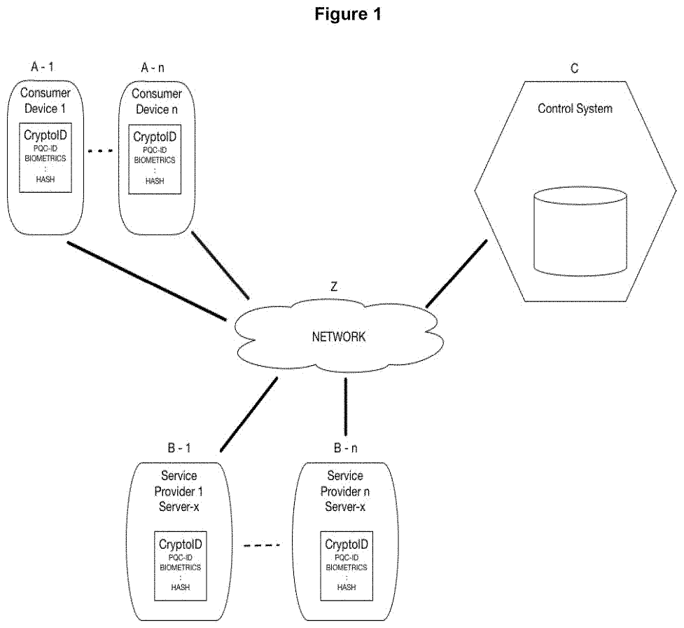

Turning to FIG. 1, a depiction of an embodiment of the present invention is shown. Three main types of participants interact with each other. Consumer devices A-1 through A-n communicate through a network Z (such as the Internet) with a Control System C and with Service Providers B-1 through B-n. The Control System stores encrypted hashes of ID information for each Consumer and for each Service Provider. The system of FIG. 1 relieves the burden on Service Providers of maintaining consumer's sensitive data.

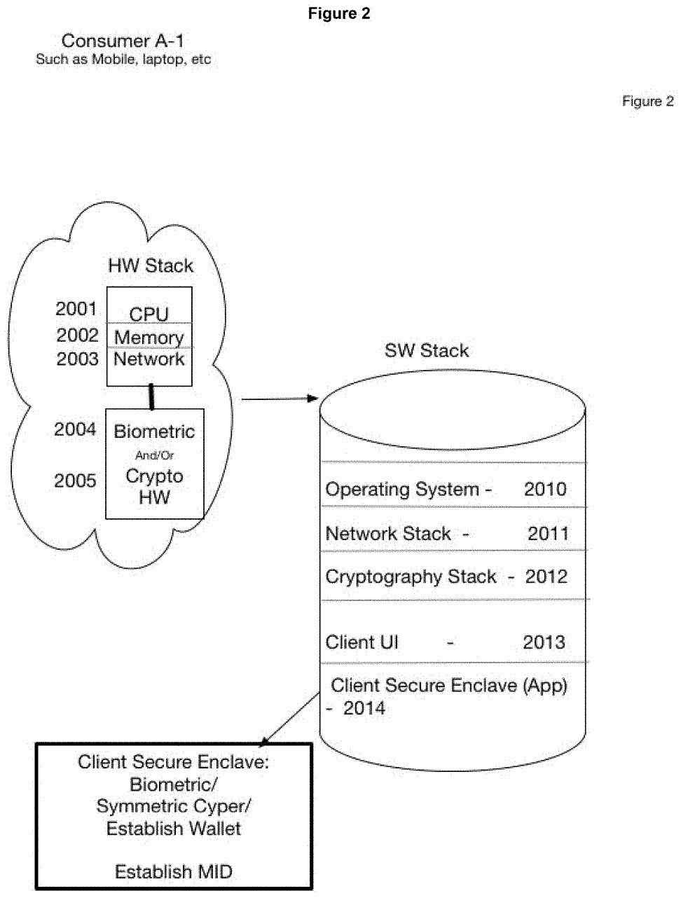

FIG. 2 shows an embodiment of a typical Consumer Device. The device contains a hardware stack that includes the central processing unit (CPU) (2001), memory (2002) and network interface (2003). In addition, the hardware stack can contain biometric identification (2004) and/or cryptographic hardware (2005) that can provide fast cryptographic functions or Post Quantum Cryptographic capabilities. The software stack includes the operating system (OS) (2010) and network stack (2011). In addition, the software stack can contain an internal cryptography stack (2012) that can provide encryption and decryption (using the hardware cryptography stack if so equipped), and can provide encryption hashes. The software stack also contains the client User Interface (UI) (2013). Finally, the software stack can contain the Client Secure Enclave (2014) application which can produce client biometric data, establish the digital wallet which is a unique identity for the Consumer/User. This can be a unique identifier that can be realized as a simple ID code or a more complex entity such as a highly sophisticated cryptographic digital signature. Finally, the Client Secure Enclave cooperates with the Control System to produce the consumer unique identifier called the MID.

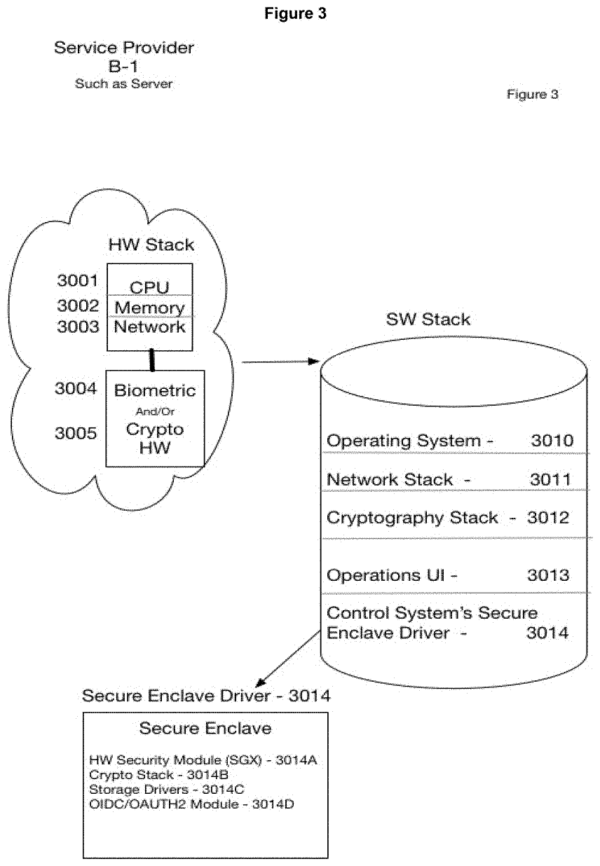

FIG. 3 shows an embodiment of a typical Service Provider. The hardware stack is similar to that of the Consumer Device containing a CPU (3001), memory (3002), network interface (3003) and biometric (3004) and/or cryptographic hardware (3005). The software stack is also similar to that of the Consumer Device in that it contains an OS (3020), network stack (3011) and cryptography stack (3012). It also contains the Service Provider User Interface (UI) (3013) and the Service Provider's secure enclave driver (3014). The secure enclave driver (3014) is a application that can interface with any of the Service Provider's security hardware (SGX for example) (3014A), an internal cryptography stack (3014B), storage drivers (3014C) that interface with the Service Provider's storage such as an Oracle database or Cloud Storage interfaces like Amazon's S3, and finally a web authentication stack that allows for OAUTH2 (or similar) authentication software interface stacks (3014D).

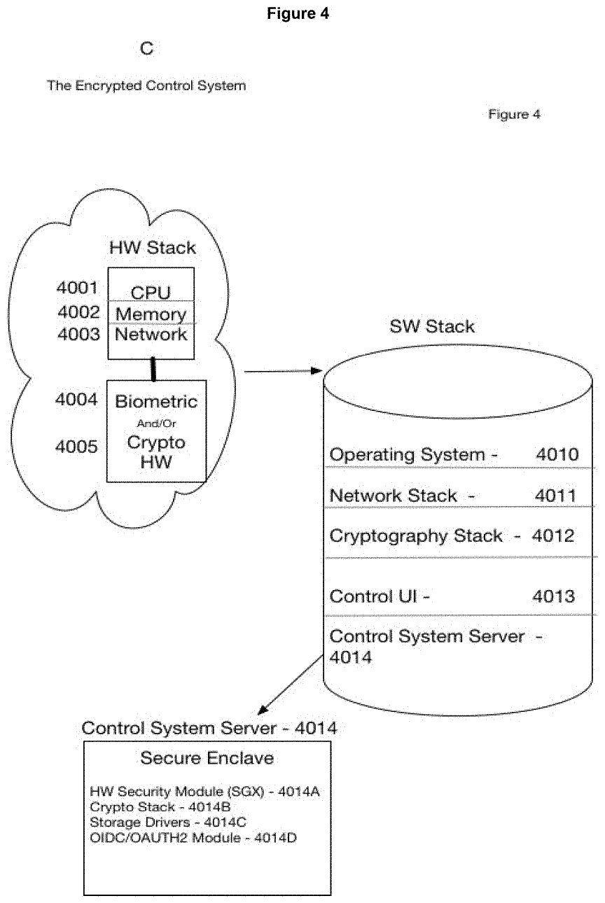

FIG. 4 shows an embodiment of a typical Control System. It's hardware stack also contains a CPU (4001), memory (4002), network interface (4003), biometric (4004) and/or cryptographic hardware (4005). The software stack also contains an OS (4010), network stack (4011) and cryptographic stack (4012), as well as the control system User Interface (UI) (4013) and a control system server (4014) which is a server that operates the Control System Secure Enclave. The Control System Secure Enclave can include a hardware security module (4014A) configured to interact with the Service Providers hardware security module (3014A), a cryptography stack (4014B), storage drivers (4014C) and a typical web authentication stack that allows for OAUTH2 (or similar) authentication software interface stack (4014D).

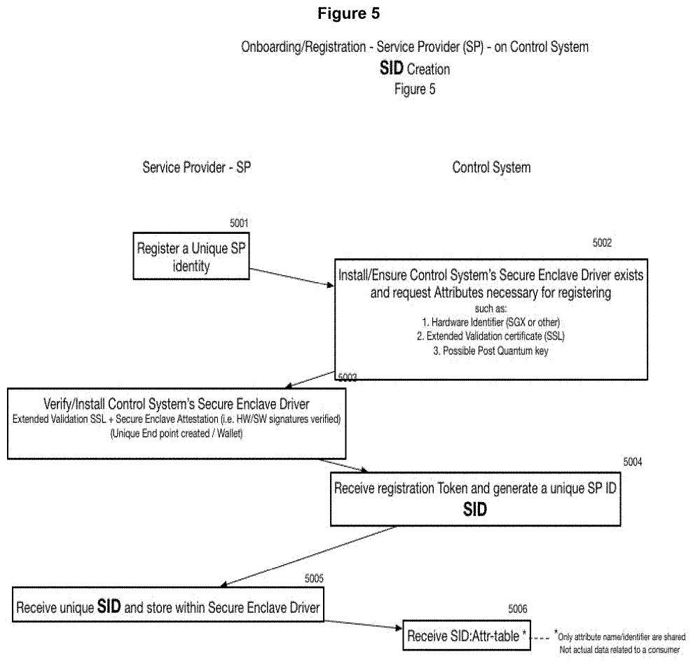

FIG. 5 shows the on-boarding process for a Service Provider. The service provider first registers a unique ID (5001) with the control system. The control system requests (5002) a list of necessary attributes for a service provider to register (5003). This can include a hardware identifier like SGX, and extended validation certificate (SSL) or other techniques such as a post quantum key. The Service Provider verifies or installs the Control System's secure enclave driver and sends a registration request to the Control System. Once the Control System receives the unique Service Provider attributes, the Control System creates an encrypted cryptographic hash for the Service Provider which is unique to this Service Provider; this is called a Service Provider Identifier or SID (5004). As part of establishing the SID, the Control System also requires that the Service Provider inform the Control System which Consumer data attributes (i.e. names of fields) the Service Provider requires for establishment of a trusted connection with the Consumer/User account this Service Provider services (such as Consumer's name, address, gender, social security number, and the like). This is called the SID attribute table. The SID is sent to, and received by, the Service Provider (5005), and next the Service provider sends the SID attribute table to the Control System (5006). This table is stored by the Control System, and the Service Provider is on-boarded.

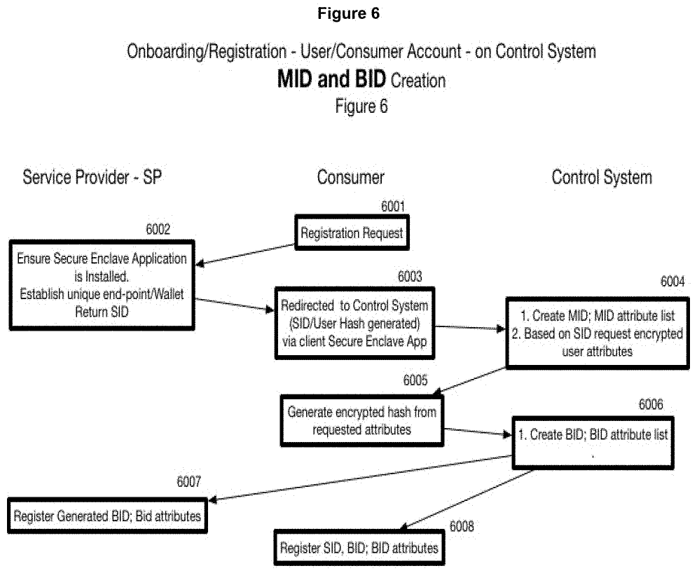

FIG. 6 shows the similar operation for on-boarding a Consumer/User. The Consumer device sends a registration request (6001) to the Service Provider. The Service Provider (6002) ensures that correct Client Secure Enclave Application is installed on the Consumer device and the Consumer has an identity within the Service Provider system. For example, in a banking environment, the Consumer has gone through appropriate KYC/AML checks. Similar procedures apply for other environments. Once the Service Provider establishes that a relationship with the Consumer/User should exist (6002), the Service Provider forwards its SID information along with a table of sensitive data attributes this Service Provider will allow the Consumer to control directly to the Consumer Device (for example the Consumer's Social Security Number (SSN)). The Consumer Device receives the SID from the Service Provider and generates encrypted hashes for data attributes that this Service Provider will make available for direct control to the Consumer, and these Consumer attributes are stored in the Control System (6003) (for example, an encrypted hash of the SSN). The Control System establishes a unique Identifier for the Consumer within the Control System (this unique Consumer/User identity is called a MID) (6004). The Control System saves the Consumer's/User's required encrypted hashes on the Control System in a table associated with this Consumer's/User's MID called a MID Attribute Table (6004). Based on the SID information received (6004), the Control System requests certain encrypted hashes for data attributes that this Service Provider requires for on-boarding Consumers/Users (6004). The Consumer Device generates encrypted hashes from the requested attributes (6005) that are sent to the Control System, where the Control System also creates a MID to SID hash relationship identifier known as a Bridge identifier (BID) (6006) that can only be generated given the particular MID and SID combination. The Control System then sends the BID and BID attribute list to both the Service Provider (6007) and the Consumer Device (6008) where they are stored.

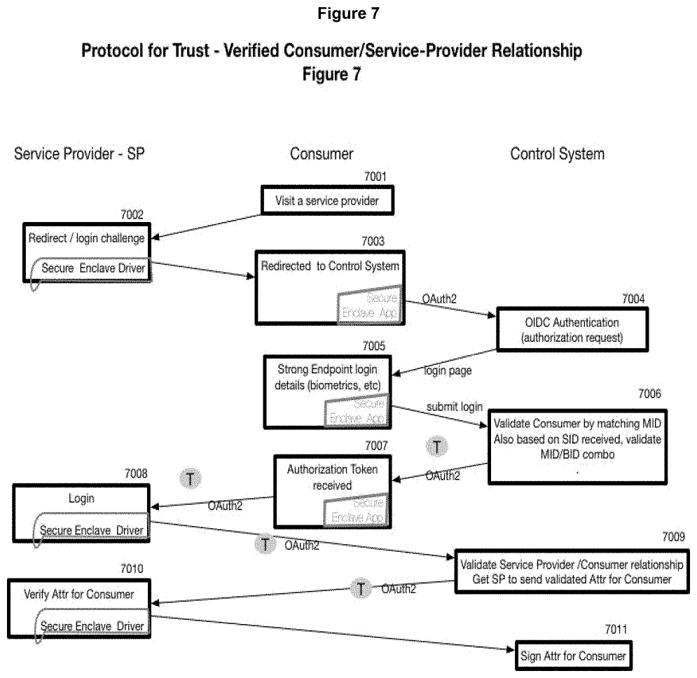

FIG. 7 is an illustration that describes the protocol for the establishment of a verified and trusted relationship between a Consumer/User and a Service Provider. This establishment of trust also verifies specific Consumer/User data attributes that the Service Provider is giving the Consumer/User direct control over. When the consumer visits a particular Service Provider (7001), the Service Provider, via the secure enclave driver, redirects the consumer to the Control System (7003). Using Oauth2, or a similar protocol, the Control System sends a login page (7004) which requires the consumer to provide a strong endpoint login (7005) that is then submitted to the Control System. The Control System validates the consumer (7006) by matching the MID, and based on the SID received, validates the MID/BID combination. An authorization token is sent to and received by the consumer (7007). The Consumer Device sends this token to the Service Provider which then allows login (7008). The Service Provider's secure enclave sends (7008) the authorization to the Control System which then validates the Service Provider/Consumer relationship (7009) leveraging the pre-established MID/SID combination to generate the BID. The Control System then orders (7009) the Service Provider to send the validated attributes for the consumer. This is done by the Service Provider along with Service Provider signatures to validate the relationship with the Consumer (7010). This information is sent to the Control System, where this information is stored (7011). Once the encrypted hashes for controlled attributes are stored within the Control System, these can be used for validation and data control purposes.

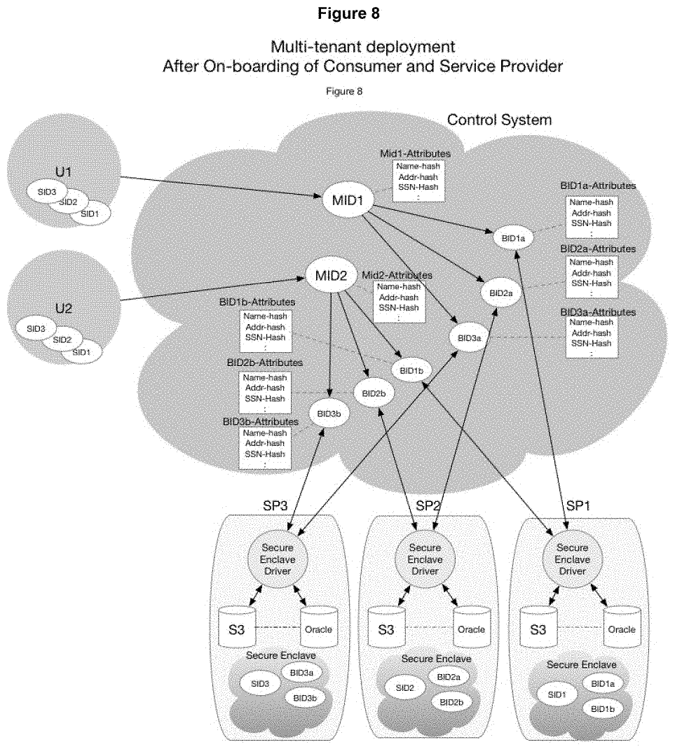

FIG. 8 depicts a real-world web of trusted identities where multiple Consumers/Users have relationships with multiple Service Providers via the Control System. The Control System manages multiple consumers (MIDs) relationships with multiple Service Providers (SIDs). Each consumer has a unique MID with a unique BID for different Service Providers. For each BID, there is BID attribute table that stores the encrypted hash that allows for control of the corresponding attribute directly at the corresponding Service Provider.

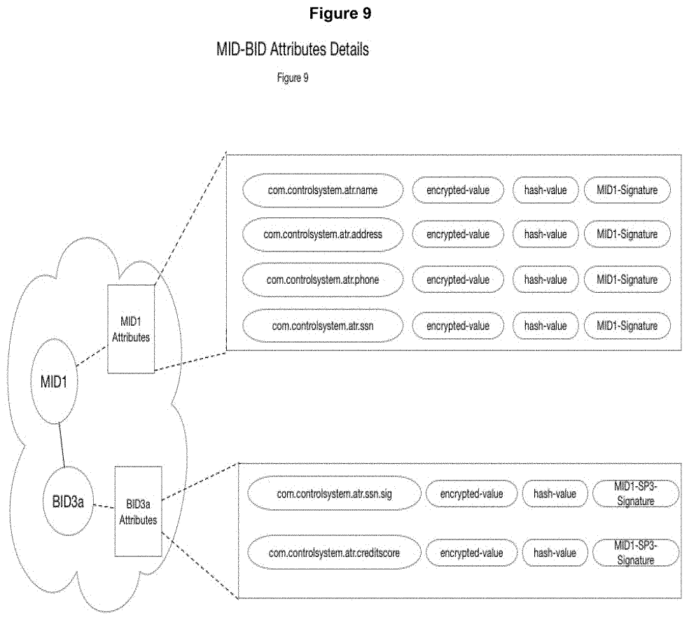

FIG. 9 depicts the relationship that establishes a given Consumer identity (MID) with a specific Service Provider's verified bridge identity (BID). Examples of the MID and BID attributes are provided that associate the attributes with corresponding Consumer signatures and Service Provider signatures that allow for control of the data relationships between the Consumer and the Service Provider. Once these attributes are verified, these attributes can be controlled by the Consumer/User directly through the Control System in a way such that the Service Provider's access to these attributes can be regulated. The BID attribute table associated with a particular BID is maintained at the Control System and only the BID identifier is stored at the Service Provider, therefore the relationship between the BID and the BID attribute table is controlled via the Control System. The MID/BID attribute tables contain encrypted versions of each of the required pieces of actual data (for example, an encrypted version of the SSN) and a hash representing that data. When the Service Provider wishes to obtain the actual piece of data, it sends the BID (for example BID3a in the depiction outlined in FIG. 9) for that particular consumer relationship and the attribute being requested for this consumer (SSN in this example) to the Control System. The Control System matches the BID hash with the MID hash it has stored for that piece of data, and the SP3/MID1-Signature (allowing this Service Provider access to this particular attribute field, which must be granted directly by the corresponding Consumer identity). If the MID-SP-signature combo allows access, the Control System allows the secure enclave on the Service Provider to gain access to the particular attribute field being requested, that is the decrypted attribute is made available to the Service Provider Device. As part of the secure relationship, the Service Provider has agreed that it will not store the decrypted piece of data outside of its secure enclave. For example, the Service Provider may use a decrypted SSN to run a credit check on a consumer. After the actual data is no longer needed, it is not stored at the Service Provider. The encrypted data, with decryption keys are stored on the Control System. These keys along with the signature key combination produce the attribute value on the fly. The data can only be produced when the right combination exists, and the data is only accessible by the Consumer, and is not present on the Control System or the Service Provider's Secure Enclave in plain text. This means that when a Service Provider wants to access a sensitive piece of information (data attribute) about a Consumer, the Service Provider makes a request into the Control System to access the data attribute. The Control System will only grant access to this data attribute to the Service Provider after checking to see if the Consumer has allowed for this action to be available for this particular Service Provider. If the Consumer allows for this access to be available for this Service Provider then the data attribute is decrypted using the Consumer's private key and then made available to the Service Provider. This means that attributes are held within the Control System at all times encrypted on a granular level by the Consumer's private key, and made available to Service Providers on demand as long as the Consumer has granted access to them.

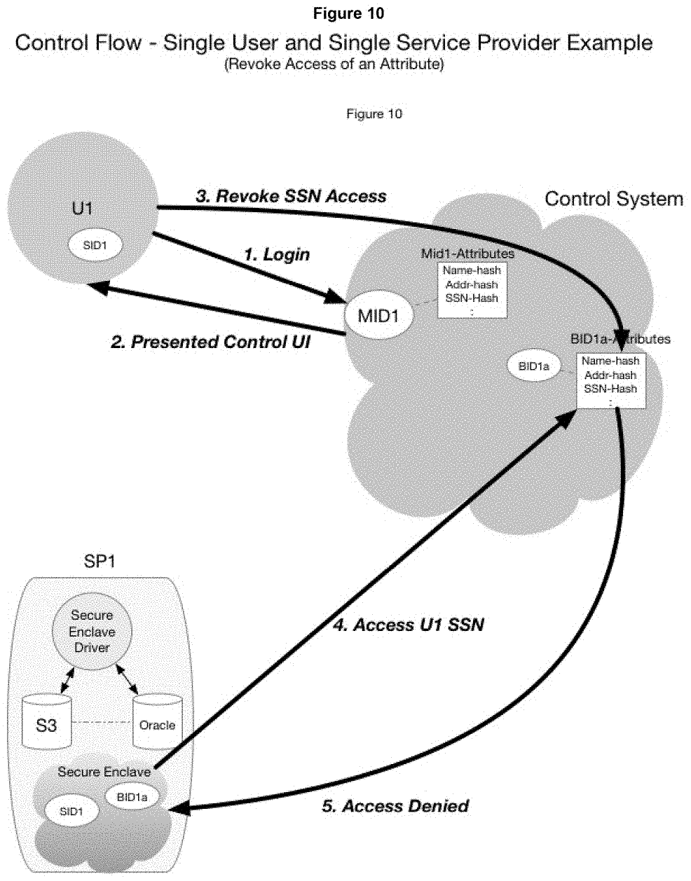

FIG. 10 shows how a consumer (U1) can revoke access to a piece of sensitive identity data such as a social security number (SSN), and how after revocation, the service provider is denied access to the information. As previously stated, the attribute gets decrypted at the Control System when the Service Provider sends the right SP signature to the Control system at the request time. This signature, combined with the Consumer Signature that exists (or not) on the BID attribute, will either allow or not allow the decryption to be successful.

In order to revoke access to a particular attribute the protocol execution flow is as follows:
1. Consumer successfully identifies itself and “logs-in” to the Control System, using one or any combination of biometrics data, post quantum keys, post quantum cryptographic algorithms, hardware/software key generators and/or other identification mechanisms that associate the Consumer's relationship to a particular Service Provider or a set of Service Providers.
2. The Consumer is presented with a Control Interface that allows them to control a set of attributes for the Service Provider or Service Providers (that is, BID attribute tables allowing control for verified relationships to particular Consumers/MIDs).
3. The Consumer revokes access to a particular field (such as SSN in this example) by revoking the MID-SP-Signature (in this case of revoking access to SSN attribute for SID1, the MID1-SP1-Signature is revoked from the BID1a-Attribute table, which in turn bars access to the com.controlsystem.atr.ssn.sig field).
4. Once the above steps have been taken and a Consumer has revoked access to a particular attribute for a particular Service Provider, when that Service Provider requests access to that particular field any time in the future, the Control System will see if the BID-SP-Signature field for that attribute grants access to this particular attribute. In this example, the SSN attribute for U1 and SP1 relationship is maintained in the BID1a-Attribute table under the com.controlsystem.attr.ssn.sig mapping to com-controlsystem.attr.ssn in the MID1-Attribute table, and the MID1-SP1-Signature field either grants or denies access to this attribute.
In this example, since the Consumer had revoked access to the SSN field for this particular Service Provider the Control System will traverse the BID1a attribute table and seeing that the MID1-SP1-Signature under the com.controlsystem.attr.ssn.sig field denies access to the Service Provider, the Control System will return an access denied notice back to the Service Provider. In return the Secure Enclave Driver on SP1 will return access denied to any application that was requesting access to this consumer attribute (SSN in this example).

In summary, the present invention defines a system and method for a Consumer/User to interface with one or more Service Providers in a fashion that is pre-authenticated directly by the Service Provider to allow Consumer/User to set up an authentication/verification system that uses pre-assigned Consumer/User data attributes that are agreed upon between the Service Provider and the Consumer. A Control System controls and orchestrates these relationships by storing encrypted hashes of sensitive data. At no time does the Control System store or have access to the Consumer/User's personal sensitive data itself. At any time, the Consumer/User can add or revoke a particular Service Provider's ability to access all or portions of the Consumer/User's information.

Several descriptions and illustrations have been presented to aid in understanding the present invention. One with skill in the art will realize that numerous changes and variations are possible while still keeping the spirit of the invention. Each of these changes and variations is within the scope of the present invention.

### TABLE OF DEFINITIONS

1) Attribute Table

Attribute Tables are data storage tables where data such as Social Security Numbers, Names, Address, and other attributes are stored in an encrypted format where encryption is done using public/private key combinations for either Consumers or Service Providers.

2) Authenticated Relationship

A relationship between a Consumer/User and a Service Provider where the Service Provider has received information to verify the identity of the Consumer/User, and where the Consumer/User controls the Service Provider's access to Personally Identifiable Information of the Consumer/User.

3) Authorization Token

Data transmitted from the Control System to a particular Consumer/User that allows only that Consumer/User to log on to a particular Service Provider and no other Service Provider.

4) Bridge

A data record that links a particular Consumer/User to a particular Service Provider.

5) Bridge Identifier (BID)

A unique encrypted identifier (also known as a private key) established by the Control System that identifies the relationship between a particular Consumer/User and a particular Service Provider.

6) Consumer Identifier (MID)

A unique encrypted identifier established by the Control System for the Consume/User

7) Consumer or Consumer/User

A person or entity that has interacted or may interact with one or more Service Providers by means of one or more computing devices.

8) Control System

A third party computing device or devices, which may include one or more servers, that at least in part establishes, and at least in part controls, one or more Authenticated Relationships between one or more Consumer/Users and one or more Service Providers.

9) Digital Wallet

A Digital Wallet is software storage capability on a Consumer device or computer where that Consumer's private information is stored in an encrypted form, such as name, social security number, crypto currency keys, medical records, etc.

10) Encryption Keys

Encryption keys are combination of public/private keys (usually digital number and/or dynamic combination of numbers generated through biometrics and post quantum key distribution concepts).

11) Hash

A string of data that is unique to a larger data set, wherein any change in the larger data set causes a change in the hash, and it is impossible to create any portion of the larger data set from the hash.

12) Identity Provider (IDP)

An entity that authenticates the identity of a participant in a transaction based on username/password combinations or multi-factor authentication.

13) Onboard

The process by which a participant registers with the Control System, wherein the Control System identifies the participant and generates secure hashes of particular data related to that participant.

14) Personally Identifiable Information (PII)

Information regarding a Consumer/User, which comprises information that identifies, relates to, describes, is capable of being associated with, or could reasonably be linked, directly or indirectly, with a particular Consumer/User or device. Examples of PII include name, signature, social security number, physical and genetic characteristics, address, telephone number, passport number, employment history, bank account number, credit card number, or any other financial information, medical information, health insurance information or any other personal or sensitive information relating to the Consumer/User.

15) Secure Enclave

A piece of software sometimes known as a “driver” that establishes the unique identity for the participant. A Service Provider Secure Enclave may include hardware tie-in to the Service Provider's computer systems via hardware security modules—such as with Intel's SGX platform. A Client Secure Enclave is an Application (App) running on a user device. The Client Secure Enclave Application establishes a unique identity for the Consumer/User. The unique identity associated with the Consumer may be created using one or a combination of biometric inputs, post quantum key distribution and other unique cryptographic key generation techniques.

16) Service Provider

An entity or individual that provides or proposes to provide services to an authorized Consumer/User.

17) Service Provider Identifier (SID)

A unique encrypted identifier for the Service Provider established by the Control System.

18) Verified Consumer Identity

A set of data that authenticates the identity of a Consumer/User

1. A method of creating an authenticated relationship between one or more consumer/users and one or more service providers through a control system, comprising:
onboarding at least one consumer/user to the control system by creating a verified consumer/user identity and storing a first hash related to said verified consumer/user identity at the control system;
onboarding at least one service provider to the control system by creating a verified service provider identity and storing a second hash related to said verified service provider identity at the control system;
wherein, an authenticated relationship is established between the consumer/user and the service provider, and
wherein, the control system does not store personally identifiable information relating to the consumer/user other than said first and second hashes, and the consumer/user has direct control of said personally identifiable information.

2. The method of claim 1, wherein the consumer/user can allow access, or can revoke access, by the service provider, to one or more items of the personally identifiable information.

3. The method of claim 1, wherein one or more items of the personally identifiable information are provided to the service provider in encrypted form, and wherein only the consumer/user can decrypt the particular items of the personally identifiable information.

4. The method of claim 1, wherein the personal identifiable information includes one or more of the following: name, credit card information, social security number, bank account number, driver's license number, address or phone number.

5. The method of claim 1, wherein an authorization token is transmitted from the control system to the consumer/user that allows the consumer/user to log on with the service provider and no other service provider. The method of claim 1, wherein a bridge identifier between the consumer/user and the service provider is created and stored on the control system, and the authenticated relationship between the consumer/user and the service provider is established at least in part as a result of the bridge identifier.

8. The method of claim 1, wherein the control system acts as a master data repository for the personally identifiable information related to the consumer/user.

9. The method of claim 8, wherein the service provider does not retain a set of said personally identifiable information.

10. The method of claim 8, wherein the service provider stores a set of said personally identifiable information.

11. The method of claim 1, wherein the control system includes one or more connectors that allow the control system to access the personally identifiable information relating to the consumer/user from one or more target systems associated with the service provider.

12. The method of claim 11, wherein the connectors use one or both of a manual process or artificial intelligence to access data from a target system.

13. The method of claim 11, wherein the connectors recognize changes to the personally identifiable information within the control system or the target systems.

14. The method of claim 1, wherein the control system contains a policy engine that at least in part controls how one or more data attributes related to the consumer/user are treated.

15. The method of claim 14, wherein the control system interacts with the consumer/user in establishing one or more policies relating to the treatment of said data attributes.

16. The method of claim 2, wherein the consumer/user can control when or for how long the one or more items of the personal identity information may be supplied to the service provider.

17. A system configured to provide an authenticated relationship between one or more consumers/users and one or more service providers comprising:
a control system, onboarding at least one consumer/user, create a verified consumer/user identity for said consumer/user, and store a first hash related to the verified consumer/user identity at the control system;
the control system onboarding at least one service provider, create a verified service provider identity and store a second hash related to the verified service provider identity at the control system;
the control system providing a link between the at least one consumer/user and the at least one service provider;
wherein, the control system establishes an authenticated relationship between the at least one consumer/user and the at least one service provider at least in part as a result of said link, without storing personal identity information relating to the at least one consumer/user other than the first and second hashes; and
wherein, the control system acts so that the at least one consumer/user has control of which items of the personal identity information relating to such consumer/user may be supplied to the at least one service provider.

18. The system of claim 17, wherein the control system permits the consumer/user to allow or to revoke access by the service provider to one or more items of the personal identity information relating to the consumer/user.

19. The system of claim 17, wherein one or more items of the personal identity information are provided to the service provider in encrypted form, and wherein, only the consumer/user can decrypt the personal identity information.

20. The system of claim 18, wherein the consumer/user can control when or for how long the one or more items of the personal identity information may be supplied to the service provider.

21. The system of claim 17, wherein the personal identity information includes one or more of the following: name, credit card information, social security number, bank account number, address, or phone number.

22. The system of claim 17, wherein an authorization token is transmitted from the control system to the consumer/user that allows the consumer/user to log on with the service provider and no other service provider.

23. The system of claim 17, wherein a bridge identifier between the consumer/user and the service provider is created and stored on the control system, and the authenticated relationship between the consumer/user and the service provider is established at least in part as a result of the bridge identifier.

24. The system of claim 17, wherein the control system acts as a master data repository for the personally identifiable information related to the consumer/user.

25. The system of claim 24, wherein the service provider does not retain a set of said personally identifiable information.

26. The system of claim 24, wherein the service provider stores a set of said personally identifiable information.

27. The system of claim 17, wherein the control system includes one or more connectors that allow the control system to access the personally identifiable information relating to the consumer/user from one or more target systems associated with the service provider.

28. The system of claim 27, wherein the connectors use one or both of a manual process or artificial intelligence to access data from a target system.

29. The system of claim 27, wherein the connectors recognize changes to the personally identifiable information within the control system or the target systems.

30. The system of claim 17, wherein the control system contains a policy engine that at least in part controls how one or more data attributes related to the consumer/user are treated.

31. The system of claim 30, wherein the control system interacts with the consumer/user in establishing one or more policies relating to the treatment of said data attributes.
